(19) United States
(12) Patent Application Publication
(10) Pub. No.: US 2006/0249648 A1
(43) Pub. Date: Nov. 9, 2006

(54) Portable mount for archery quiver

(76) Inventor: Shane A. DeVoe, Ortonville, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 11/417,694

(22) Filed: May 4, 2006

Related U.S. Application Data
(60) Provisional application No. 60/677,640, filed on May 5, 2005.

(51) Int. Cl. F16M 11/00

(52) U.S. Cl. 248/682

(57) ABSTRACT

A device used to attach arrow quivers and hunting accessories to an external structure, such as a tree trunk or limb. The device is comprised primarily of a rigid main body to which a secondary adapter mount and a mounting strap or cord may be attached. The main body is lightweight and compact in size so as to be easily transported in and out of the field. The main body also contains a cleat around which the mounting strap or cord can be wrapped after encircling the external structure and a tapered slot into which the loose end of the mounting strap or cord can be wedged to prevent unwrapping.

This application is based upon provisional patent application Ser. No. 60/677,640, filed May 5, 2005, entitled “Portable, Lightweight, Non-Permanent Device for Support of Arrow Quivers and Hunting Accessories While in the Field.” Applicant claims the priority of the provisional application.

### BACKGROUND OF THE INVENTION

1. Field of the Invention

The invention relates to a portable structure for supporting an arrow quiver and hunting accessories while in the field.

2. Background Art

It is generally the case that archers prefer to have an arrow quiver that is attached to their bow while traversing to and from their blind, but would prefer to remove the quiver and arrows from their bow once they are in the blind, whether on the ground or in an elevated platform. After removing the quiver and arrows from their bow, the archer is faced with the problem of storing the quiver in such a fashion as to be within easy reach and firmly supported such that should a second arrow be needed, retrieval can be made simply and quietly. Additionally, particularly while hunting from elevated stands, other accessories such as game calls and binoculars are beneficial to have stowed within easy reach. As a solution to these problems, this invention relates to supports for hunting accessories, and more specifically to a device that combines the support of a quiver loaded with arrows with support hooks from which other accessories may be hung and provides a manner by which the device can be non-permanently attached to an external support, such as a tree trunk or limb.

Certain art references describe devices that attach a quiver mounting apparatus to an external support by use of a threaded fastener, spikes or nails, or a strap with buckles, D-rings or tied knots. The first two methods when used on a tree can cause damage to the tree and require additional tools and/or some degree of strength. The third method requires some added mechanism (buckle or D-rings) or a somewhat cumbersome knot that may be difficult to tie and untie in typical cold hunting conditions.

The present invention overcomes these disadvantages by providing an attachment method that respects the environment, is low cost to manufacture, requires no exceptional strength or coordination to install, can be installed quietly, and can be installed without additional tools. The present invention also teaches a device that combines additional functionality over prior art by combining the quiver mounting support with molded-in or integral accessory hooks as well s a molded-in or integral broadhead wrench.

### SUMMARY OF THE INVENTION

The present invention provides a solution to the problems described in the form of a device that the archer can easily transport to and from a ground blind or tree stand. This device can be attached without tools, great effort or damage to a post, tree trunk, limb or other external structure and provides a firm support with a detachable mount for a typical bow mounted quiver. Due to its ease of set-up and removal, this device can be left in place at the hunting stand for later retrieval or taken down at the end of each hunt. Additional advantages and features of the device are built-in storage for the mounting cord or strap, provisions for hanging hunting accessories other than the quiver, built-in broadhead wrench and body configuration that adapts well to varying diameters of external mounting structures.

These characteristics, in accordance with the invention, are presented in a device that consists of a main body primarily rectangular in shape and hollowed from the back, forming a box-like structure that is both strong and lightweight. Formed into the center section of the main body is a second, smaller rectangular pad that becomes the primary mounting area to accept the attachment of a mounting adapter as used by most detachable bow-mounted quivers. To one side of this pad is a transverse hole through the main body of the device through which a cord or rope may be tied securely. Directly below the pad and also passing transversely through the main body is an opening designed to accept multiple broadhead styles, which allows the invention to be utilized as a broadhead wrench either in the free state (held by hand) or more preferably while attached rigidly to the external structure. Located to each side of the broadhead opening are dual slots extending to the edges of the main body and angled in such a way as to form hook features for hanging additional hunting accessories in conjunction with the quiver.

The device can be quickly attached to an external support by encircling the support with the rope or cord that has been tied to the main body, and after pulling the rope or cord taut, securing the loose end by wrapping it around a cleat that protrudes from the main body on the side opposite the cord attachment hole. After wrapping the cord around the cleat, unwrapping of the cord is prevented by wedging the cord in a tapered slot provided in the main body of the device.

### BRIEF DESCRIPTION OF THE DRAWINGS

FIG. 1 is an exploded isometric view of the components comprising the invention;

FIG. 2a is a front view of the invention (note: all views in FIG. 2 depict the invention with the mounting cord or rope not shown for clarity);

FIG. 2b is a left side view of the invention;

FIG. 2c is a top view of the invention;

FIG. 2d is a right side view of the invention;

FIG. 2e is a bottom view of the invention;

FIG. 2f is a back view of the invention;

FIG. 3 is a detail view of stepped shape of the main body that adapts to varying diameter external supports;

FIG. 4 is a close-up view of the invention as it mounts to a tree showing the use of the mounting cleat and wedging-slot to secure the mounting cord or rope;

FIG. 5 is a view of the invention as intended for use with quiver and accessories installed;

FIG. 6 is a view of the invention with the mounting cord/strap stowed for transport to and from the field; and

FIG. 7 is a view of the invention being used as a broadhead wrench.

### DETAILED DESCRIPTION OF AN EMBODIMENT OF THE INVENTION

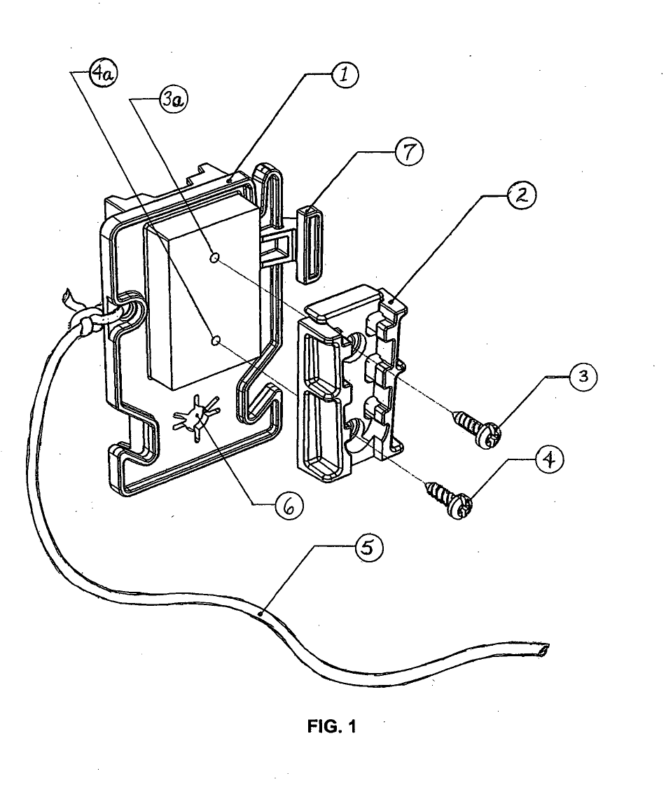

The device for support of arrow quivers and hunting accessories as generally illustrated in FIG. 1 is comprised of a main body 1, to which is attached a rope or cord 5 and a separate adapter mount 2. The main body is generally rigid in nature, with a rectangular shape that is hollowed out from the back to form a basically box-like structure. The size (approximately 4.5 in. long×3 in. wide×2 in. deep) and shape of the main body make for a device that is both strong and lightweight, and readily fits into the coat pocket for easy transport to and from a hunting blind. Manufacture of the main body would preferably be from an injection-moldable polymer such as a filled polypropylene or nylon, however, other methods of manufacture and materials could be utilized such as metal stamping or casting. Integral to the main body is a cleat 7, used to hold the attaching cord or rope once it has encircled an external support structure, a transverse opening 6 shaped as shown in FIG. 1 so as to allow several styles of broadheads to be inserted thereby effectively making the main body of the invention useful as a broadhead wrench and a pair of spaced holes 3a and 4a into which two threaded fasteners 3 and 4 can be driven after passing through the quiver adapter mount 2. The preferred spacing of holes 3a and 4a would be approximately 1.25 inches, so as to be equal to the tapped holes spacing common to the riser section of most compound bows currently available, where quiver and sight-mounting brackets typically attach. By spacing the holes in the main body in this manner, any number of quiver mounting adapters may be utilized as would be supplied with various brands of quivers. Adapter 2 depicts a design that would support attachment of several quiver brands, where a tapered slot is molded into the adapter with the narrow end being blind and the general cross-section of the slot being “T” shaped.

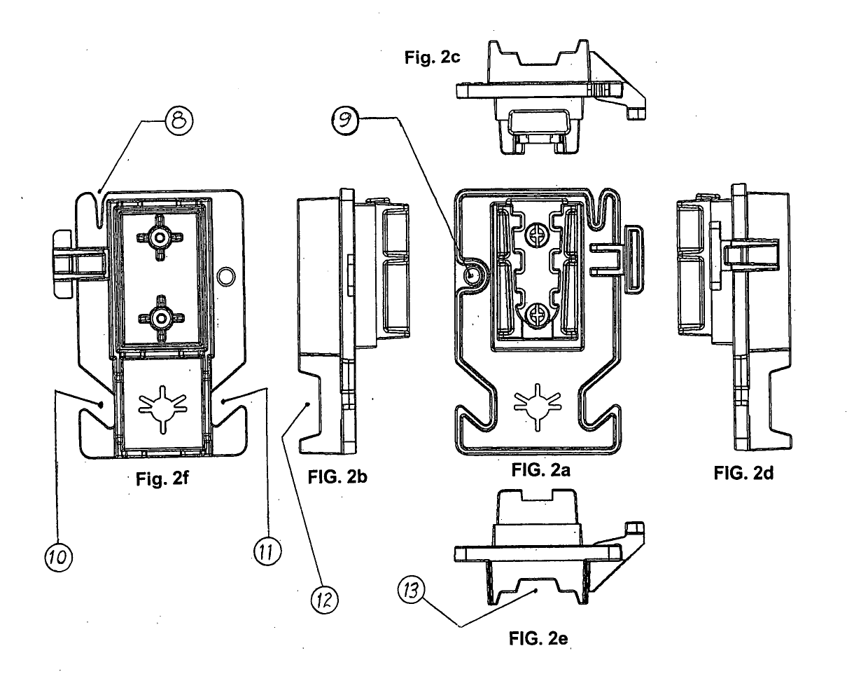

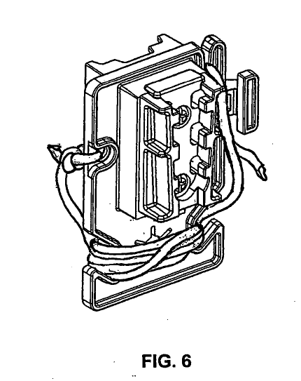

As shown in FIG. 2a and FIG. 2f, the main body of the device would also be molded with a tapered slot 8 located near the cleat into which the mounting rope or cord may be wedged as a means of securing the loose end after it is wrapped around the cleat. A hole 9 would provide a means for attaching the fixed end of the mounting rope or cord, and a pair of downward sloping slots 10 and 11 would serve not only as areas on which additional hunting accessories could be hung but would provide a groove into which the mounting rope could be wrapped when not in use for tangle free storage. A groove 12, shown in FIG. 2b, molded into the back of the main body also helps to maintain the stowed rope in an untangled state. FIG. 6 shows the rope stowed as intended by the preferred embodiment of the device.

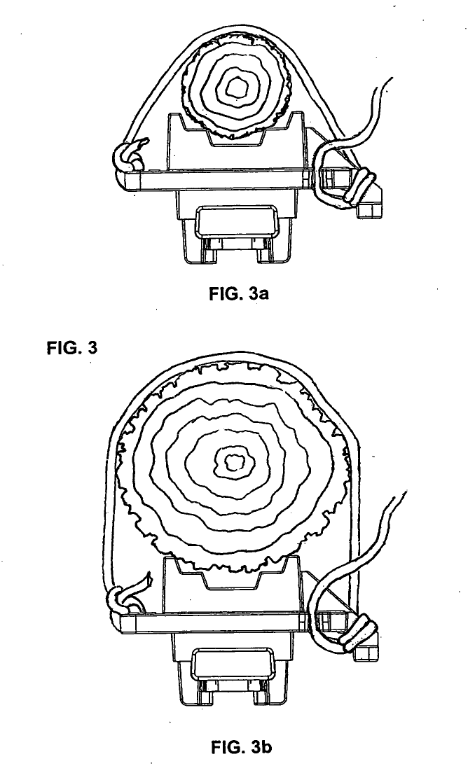

Referring to FIG. 2e, a stepped or possibly tapered shape 13 molded into the main body on the top and bottom portions of the “box” structure would provide a mounting shape that adapts to various diameter support structures for the device. FIGS. 3a and 3b show how this shape interfaces to a small diameter and larger diameter tree trunk or branch, respectively, thereby producing a stable mounting stance.

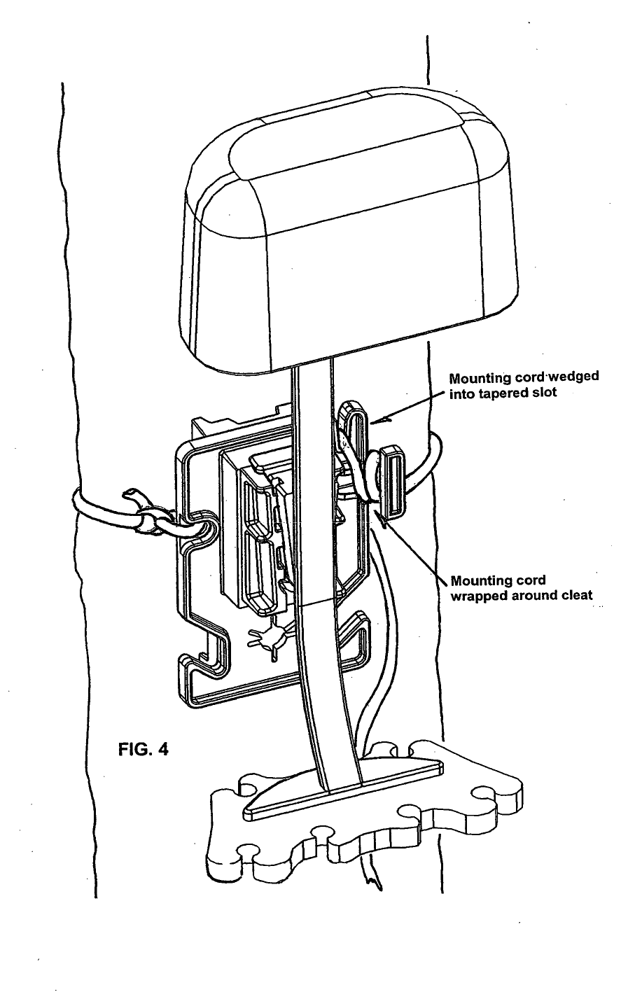

FIG. 4 shows a close-up view of the intended mounting configuration of the invention, where the mounting cord is wrapped around the cleat extending from the main body and then the loose end is held firmly in place by wedging it into a tapered slot. The cleat shown is one of many shapes that could be utilized to secure the mounting cord, and, if desired, the loose end of the cord could be retained by an overlapping loop on the cleat in lieu of the use of the wedging slot.

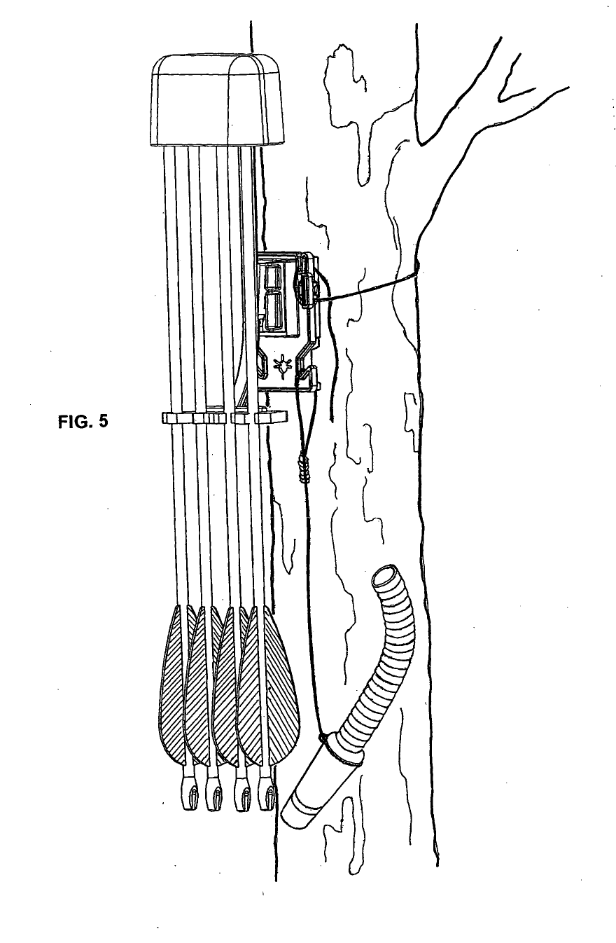

As seen in FIG. 5, when installed firmly to an external support, the preferred embodiment of the invention provides a simple, secure mounting platform for an arrow with quivers and additional hunting accessories that are preferably to have close at hand while hunting.

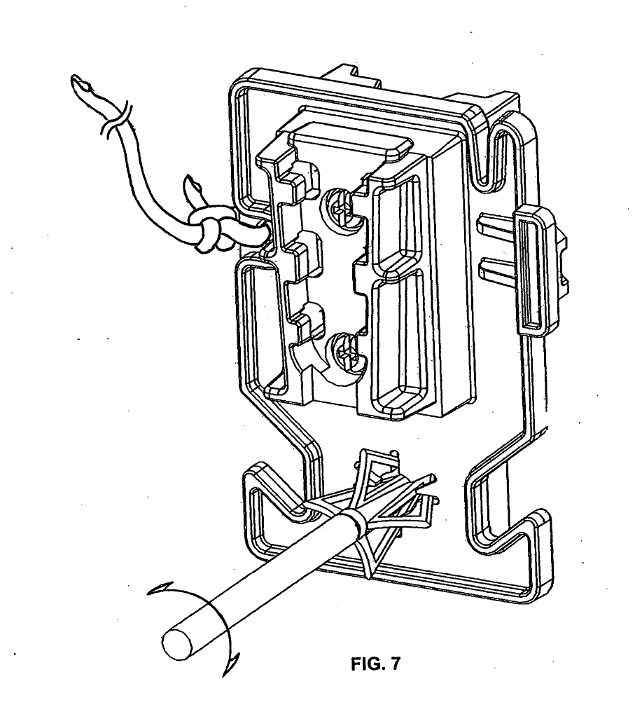

Referring to FIG. 7, the preferred embodiment of the invention becomes a useful broadhead wrench when an arrow tipped with a broadhead is inserted into the opening at the bottom of the main body of the device. Due to the box-like shape of the device which offsets the broadhead opening away from the external support, the wrench feature can be used while the device is in the free state or while it is attached to a supporting structure.

The main body is characterized by a molded opening suitable for use as a broadhead wrench, a channel serving as an area into which the mounting strap or cord can be wrapped for storage and molded-in hooks which can serve as supports for hunting accessories, such as but not limited to game calls and binoculars. The secondary adapter mount is fastened to the main body of the device with threaded fasteners or other fastening means and provides a suitable mounting surface for an arrow quiver to be easily attached and removed. In this configuration, the device can be left attached to the external structure and the quiver and accessories can be installed and removed without necessitating removal of the device.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A portable mount structure for supporting an archery quiver, the quiver having an elongated quiver body, a protective cap secured to one end of the elongated quiver body for receiving archery arrowheads, and a support secured to another end of the elongated quiver body for supporting archery arrow shafts; the portable mount comprising:
a rigid main mount body;
an attachment cord for the main body adapted to surround a fixed support structure, one end of the cord being fixed to one part of the main body and the other end being releasably secured to another part of the main body at a location spaced from the one part, whereby the elongated quiver body is held securely in place in a generally vertical position.

2. The portable mount structure set forth in claim 1 wherein the portable mount structure includes a generally vertical slot with tapered slot sides;
the elongated quiver body having a tapered section intermediate its ends, the tapered section being adapted to register with the tapered slot, whereby the archery quiver may be supported firmly on the fixed support structure.

3. The portable mount structure set forth in claim 2 wherein the main body is defined by separate body components, one body component being secured to the fixed support structure and the other being adapted to be releasably assembled to the one body component by fasteners;
the generally vertical slot being formed in the other body component whereby the archery quiver can accommodate multiple body components with slots of varying sizes and shapes.

4. The portable mount structure set forth in claim 3 wherein the main body is formed with a cleat on one side thereof, whereby the attachment cord can readily be attached to the main body as the attachment cord encircles the cleat.

5. The portable mount structure set forth in claim 4 wherein the main body has a slot for receiving and securing the end of the cord after the cord is attached to the cleat.

6. The portable mount structure set forth in claim 5 wherein the main body has slots on at least one side thereof, the slots defining hangers for supporting archery accessories.

7. The portable mount structure set forth in claim 6 wherein the main body includes a hole with a hole axis in a generally horizontal position when the archery quiver is secured to the fixed support structure; and
hole extensions in the main body extending generally radially from the hole axis, the extensions being adapted to receive broadhead features, the main body and the hole defining a broadhead wrench, whereby a broadhead can be attached manually to a threaded arrow shaft.

8. The portable mount structure set forth in claim 1 wherein the main mount body includes support walls extending from the main mount body and adapted to engage the fixed support structure at spaced locations whereby the portable mount structure may be secured to a rounded fixed support structure.

9. The portable mount structure set forth in claim 1 wherein the main mount body defines an enclosure to accommodate storage of the attachment cord when the main mount is secured to the fixed support structure.
